(19) United States
(12) Patent Application Publication
(10) Pub. No.: US 2026/0185588 A1
(43) Pub. Date: Jul. 2, 2026

(54) BELT TENSIONER WITH RETAINER CLIP FOR A NON-BOLTED PULLEY

(71) Applicant: MUVIQ USA, LLC, Roseville, MI (US)

(72) Inventor: Anthony E. Lannutti, Fayetteville, AR (US)

(73) Assignee: MUVIQ USA, LLC, Roseville, MI (US)

(21) Appl. No.: 19/430,892

(22) Filed: Dec. 23, 2025

Related U.S. Application Data
(60) Provisional application No. 63/739,068, filed on Dec. 26, 2024.

(51) Int. Cl. F16H 7/12; F16H 7/08

(52) U.S. Cl. CPC F16H 7/1281; F16H 2007/081; F16H 2007/0842; F16H 2007/0865; F16H 2007/0893

(57) ABSTRACT

A high-offset belt tensioner has a base having a pivot tube that defines a first axis of rotation, an arm having a pivot tube-receiving body rotatably seated over the pivot tube and having a pulley pivot tube that defines a second axis of rotation. A torsion spring seated around an exterior surface of the pivot tube-receiving body with a first spring end attached to the base and a second spring end oriented and seated in the pulley pivot tube. A pulley is seated on the pulley pivot tube and rotatable thereabout. The pulley is secured to the pulley pivot tube by a monolithic dust cover clip without the use of a pulley bolt.

### RELATED APPLICATIONS

This application claims the benefit of U.S. provisional Application No. 63/739,068, filed Dec. 26, 2025, the entirety of which is incorporated herein by reference.

### TECHNICAL FIELD

The present invention relates generally to belt tensioners and more particularly to a belt tensioner, whether standard or high-offset, having a pulley journaled to an arm and having a monolithic dust cover clip or dust cover retaining clip assembly effective to fasten the pulley thereto without a pulley bolt.

### BACKGROUND

Belt tensioners have a pulley for engaging a belt of a drive or engine system to provide tension to an endless belt during its belting route. The pulley is traditionally mounted to the arm of the belt tensioner using a bolt, as shown in U.S. Pat. No. 7,186,196. A bolt is an effective fastener, but there is always a need for a cost effective faster method of fastening the pulley to the arm of a belt tensioner, especially when another beneficial feature such as a dust cover can be integrated therewith to protect the bearings.

### SUMMARY

In all aspects, belt tensioners are disclosed that have a support base having a pivot tube that defines a first axis of rotation, an arm operatively seated over the pivot tube for rotation about the first axis of rotation and having a pulley mount that defines a second axis of rotation, a torsion spring having a first end in operative engagement with the support base and a second end in operative engagement with the arm to bias the arm in a belt tensioning direction, and a pulley having a bearing seated on the pulley pivot tube and rotatable thereabout. The belt tensioner being characterized in that the pulley is secured to the pulley pivot tube by a monolithic dust cover clip without the use of a pulley bolt. In some or all embodiments, the arm has can have the pulley mount protruding from the arm in a direction opposite of the arm arbor, thereby defining a high-offset position for the pulley. In all aspects, the torsion spring can be an exposed torsion spring.

In all embodiments, the pulley mount has an open end facing the spring and in which the second spring end is seated. This belt tensioner can also include an arm plate seated in a collared bowl of the arm arbor in engagement with a first end of the pivot tube, and during assembly, the arm plate is deformed to act as a spring plate.

In some embodiments, the base comprises a locating pin extending from a mounting surface of the base. The locating pin can be at a positioned opposite a spring abutment feature.

In all embodiments, the pulley mount can terminate with a reduced diameter stud against which the monolithic dust cover clip is seated. Likewise, the monolithic dust cover clip can be press-fitted to the pulley mount in contact with an inner race of the bearing to provide an axial force on the bearing. The monolithic dust cover clip can also have a dust cover flange extending over the upper surface of the bearing. The monolithic dust cover clip can have an axially extending generally cylindrical flange terminating with an upwardly angled annular lip that is press-fitted to the pulley mount with the cylindrical flange seated in the bore of the bearing against the inner race. Additionally, the monolithic dust cover clip can include an axial deflection as the transition between the cylindrical flange and the dust cover flange. This axial deflection engages the mounting ring with the inner race of the bearing. The generally cylindrical flange can be angled radially outward to define a cone-shaped nose. In some embodiments, the dust cover flange is deflected upward to define a labyrinth seal over the upper surface of the bearing.

### BRIEF DESCRIPTION OF THE DRAWINGS

FIG. 1 is a side perspective view of a first embodiment of a high-offset belt tensioner.

FIG. 2 is a top, plan view of the first embodiment.

FIG. 3 is a longitudinal cross-sectional view along line A-A in FIG. 2.

FIG. 4 is an exploded perspective view of the first embodiment.

FIG. 5 is a side perspective view of the arm of the first embodiment.

FIG. 6 is a bottom plan view of the arm.

FIG. 7 is a side perspective view of the base of the first embodiment.

FIG. 8 is a bottom perspective view of the base.

FIG. 9 is an enlarged view of the detail of box B in FIG. 3.

FIG. 10 is an enlarged, longitudinal cross-sectional view of the dust cover of FIG. 3 having a retainer clip added thereto and a solid pulley pivot tube.

FIG. 11 is a top perspective view of the retainer clip of FIG. 10.

FIG. 12 is a bottom perspective view of a second embodiment of a belt tensioner, the bottom surface being the surface that mounts against an engine or engine component, having the dust cover and retainer clip as the fastening system for the pulley.

FIG. 13 is a top perspective view of one embodiment of a monolithic dust cover clip.

FIG. 14 is an enlarged, longitudinal cross-sectional view of the embodiment of FIG. 13 installed against the pulley pivot post of a belt tensioner to clamp a pulley to the pulley mount.

FIG. 15 is a top perspective view of a second embodiment of a monolithic dust cover clip.

FIG. 16 is an enlarged, longitudinal cross-sectional view of the second embodiment of the monolithic dust cover clip installed to clamp a pulley to the pully mount.

FIG. 17 is a top perspective view of a third embodiment of a monolithic dust cover clip.

FIG. 18 is an enlarged, longitudinal cross-sectional view of the third embodiment of the monolithic dust cove clip installed to clamp a pulley to the pully mount.

### DETAILED DESCRIPTION

The following detailed description will illustrate the general principles of the invention, examples of which are additionally illustrated in the accompanying drawings. In the drawings, like reference numbers indicate identical or functionally similar elements.

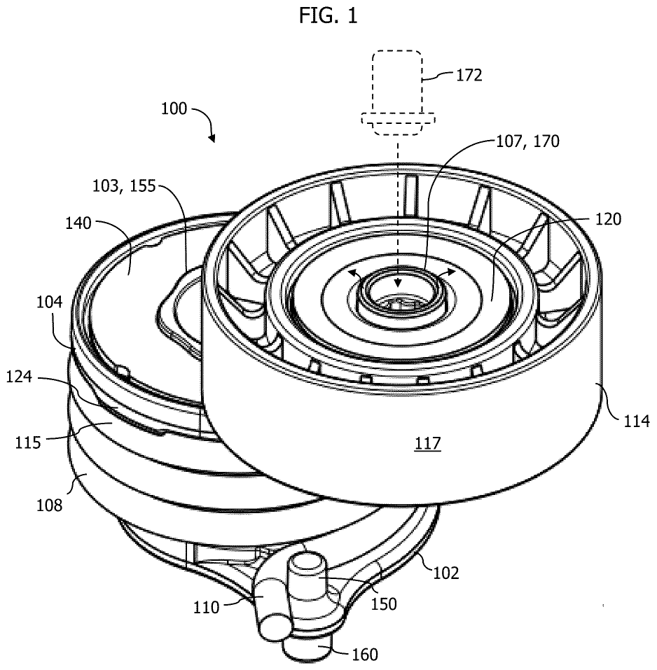

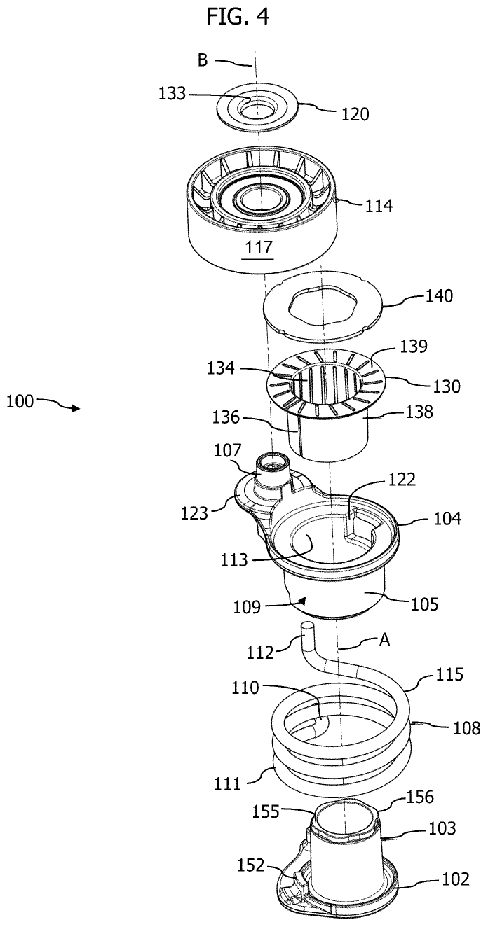

Referring to FIGS. 1-4, a first embodiment of a high-offset belt tensioner 100 that provides tension upon an endless belt of a belt system often found in engine systems, such as a transmission belt system, is exemplified. A high-offset belt tensioner is also referred to as a Zed type belt tensioner. As labeled in FIG. 3, in a high-offset belt tensioner, a plane coincident with a hub load force (arrow X) that is transverse to the pulley rotation axis (B) is axially offset above a plane coincident with a torsion spring reaction force (arrow Y) in the main body of the tensioner 100. The tensioner 100 includes a support base 102 having a pivot tube 103 that defines a first axis of rotation (A) (labeled in FIG. 4), an arm 104 having a pivot tube-receiving body 105, also referred to as an arm arbor, rotatably seated over the pivot tube 103 and having a pulley pivot tube 107 that defines the pulley axis of rotation (B). A torsion spring 108 is seated around an exterior surface 109 of the arm arbor 105 with a first spring end 110 attached to the base 102 and a second spring end 112 oriented and seated in the pulley pivot tube 107. The orientation of the second spring end 112 as best seen in FIG. 4 is upward in alignment with rotational axis B. A pulley 114 is seated on the pulley pivot tube 107 and is rotatable thereabout. A dust cover 120 is seated on the pulley, more specifically on the roller bearing 116.

The pulley 114 is preferably journaled to the pulley pivot tube 107 by a roller bearing 116, visible in the cross-sectional view of FIG. 3. The pulley 114 has a belt-engaging surface 117. In the figures, the belt-engaging surface is shown as a flat surface, but it is not limited thereto. The belt-engaging surface can be textured or have ribs such as V-ribs or cogs for belt engagement. The pulley can be made of any suitable material, whether metal, plastic, or a composite thereof. The dust cover 120 is coaxially mounted on the pulley pivot tube 107 to enclose the roller bearing and to secure the pulley 114. To seal the bottom of the pulley 114 against debris and contamination an annular seal (not shown), such as a V-ring, X-ring, or O-ring seal can be seated in operative engagement with the roller bearing 116 and an annular shoulder 123 of the arm 104 from which the pulley pivot tube 107 extends.

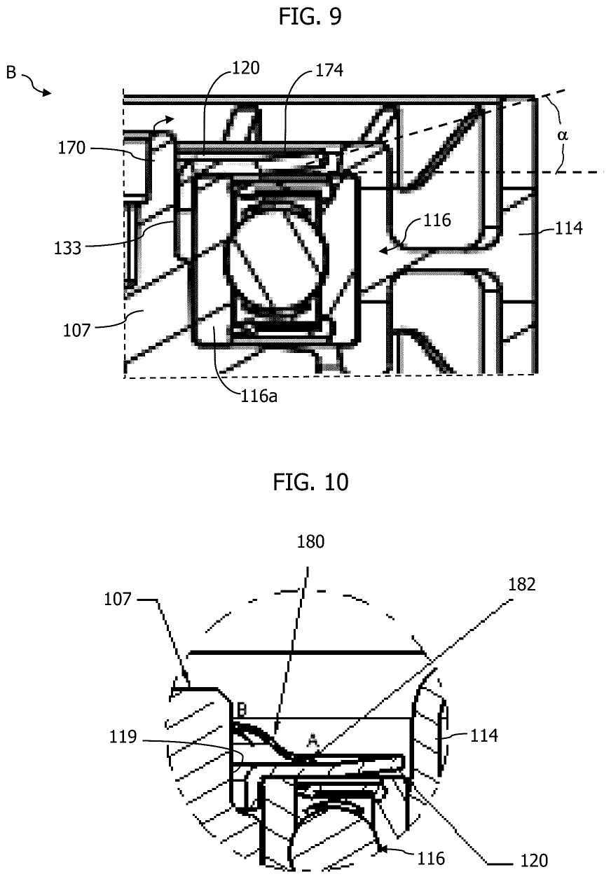

As best seen in FIGS. 1 and 3, the dust cover 120 is mounted on the pulley pivot tube 107 to enclose the roller bearing and to secure the pulley 114 without the use of a bolt. These figures show the initial assembly, prior to a manufacturing step of deforming the first end 170 of the pulley pivot tube 107, such as by radial riveting, peening, or swagging, toward the dust cover 120 to retain the pulley 114 without the use of a pulley bolt. A peen 172, shown in FIG. 1 in dashed lines, will deform the first end 170, thereby folding the first end 170 over and radially outward onto the dust cover 120. As best seen in FIGS. 3 and 9, the dust cover 120 has a flange 133, an annular flange oriented axially, that is sandwiched between the pulley pivot tube 107 and the roller bearing 116 (against the inner race 116a of the roller bearing). The dust cover 120 protects the inner race from deformation during the deformation process. An annular portion 174 of the dust cover 120 most proximate and defining the outer diameter thereof deflects upward away from the roller bearing at a first angle (α), thereby forming a labyrinth seal.

Referring to FIGS. 1-4, the torsion spring 108 applies a torsional spring force on the arm 104 in a direction toward a belt (i.e., a belt engaging direction) such that the pulley 114 applies a corresponding tension force upon the belt. Here, torsional spring 108 is a coil spring, such as a round wire coil spring. The coil spring is an exposed spring—there is no spring case present in which the torsion spring 108 is enclosed. This reduces the cost of the tensioner. As noted above, the torsion spring 108 has the second spring end 112 oriented and seated in the pulley pivot tube 107, which results in the torsion spring 108 moving with the arm and counteracting the hub load force through its entire sweep. With the second spring end 112 in the pulley pivot tube 107, the net force back to the pivot tube 103 of the base is zero. As labeled in FIG. 3, the spring reaction force Y pushes radially inward on a damper tab 132 protruding through an open window 122 in the arm arbor 105 of the arm 104 and directs this force to the spring abutment feature 150 of the base 102, i.e., to ground therethrough. One advantage provided thereby is the ability to reduce the amount of material in the arm 104 because the torsion spring 108 carries the load back to the pivot tube 103.

The tensioner 100 further comprises a bushing 130 seated within the arm arbor 105 between the pivot tube 103 and an interior surface 113 of the arm arbor 105. The bushing 130 includes the damper tab 132 extending through the open window 122 of the arm and is in active engagement with a coil of the torsion spring 108 (see FIG. 3). The damper tab 132 is dimensioned such that it extends through the arm arbor 105 and is accessible to or by the spring 108 as the spring contracts (has a smaller outer diameter) upon unwinding. As best seen in FIG. 4, the bushing 130 includes a cylindrical body 138 having a first open end and a second open end, and an annular flange 139 extending radially outward from the first open end. The damper tab 132 protrudes outward from the cylindrical body 138 and is shaped to be received in the open window 122 of the arm arbor 105. With the damper tab 132 and window 122 so mated, the bushing 130 is rotatable with the arm 104. The cylindrical body 138 includes an axially oriented slit 136 through the cylindrical body 138 and through the annular flange 139, as such the slit 136 extends from the first open end to the second open end. The slit 136 is generally positioned opposite the damper tab 132.

During operation of the belt tensioner 100, when the torsion spring is wound tighter about the arm arbor 105, the damper tab 132 is pressed radially inward, which compresses the cylindrical body 138 of the bushing against the pivot tube 103 for frictional engagement therewith to damp movement of the arm. This provides positional frictional damping to the movement of an arm 104 as the spring is wound in response to a belt load or other prevailing force of the endless power transmitting element which is tightening in the span where the tensioner resides. The winding direction of the torsion spring 108 occurs when increasing tension causes the endless belt to lift the tensioner's arm 104 in a direction away from the endless belt. The tensioner resists rotating in the winding direction with a frictional damping force as the spring torque increases but reduces the frictional damping force when the torque decreases.

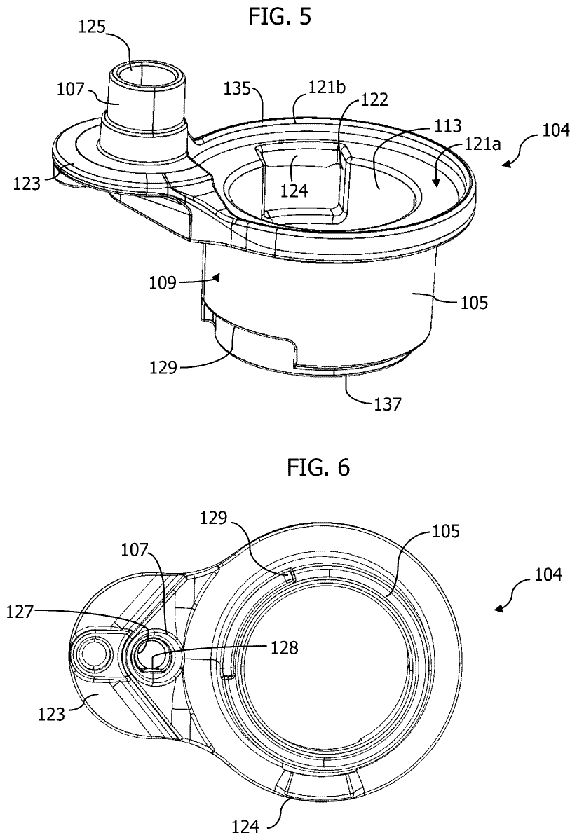

With reference to FIGS. 4 and 5, the pivot bushing 130 is seated with the annular flange 139 between an upper surface 121a of the arm arbor 105 and the arm plate 140. The bushing 130 is typically formed from wear resistant plastic and has a plurality of troughs 134 for retention of grease in a first surface facing the pivot tube 103 and a second surface facing the arm plate 140. The annular flange 139 and the bushing 130, as a whole, act as a bearing surface for the rotation and translation of elements of the tensioner along and about the pivot axis. While the bushing 130 in this embodiment is a wear resistant plastic, it is within the scope of the invention to use other suitable bushing materials or bearing structures.

Referring to FIGS. 3-6, the arm arbor 105 extends from the arm 104 about the first axis A. The arm arbor 105 is shaped as a cylindrical sleeve that has an open top end 135 and an open bottom end 137, relative to the orientation of the page with respect to FIGS. 4 and 5. The arm arbor 105 defines an open window 122 therethrough, i.e., a slot that is open from the exterior surface 109 of the arm arbor 105 to the interior surface 113 thereof. The open window 122 is located most proximate the open top end 135 and proximate the pulley pivot tube 107 such that a last coil 115 of the torsion spring 108 extending from the second spring end 112 will be in operative engagement with the damper tab 132 of the bushing 130 which is seated in the open window 122, as shown in FIGS. 1 and 3. The open window 122 has an exterior overhang 124 that is shaped to receive the last coil 115 of the torsion spring 108 to aid in holding the last coil against the damper pad 132.

As best seen in FIG. 5, the open top end 135 of the arm arbor 105 can be shaped as a collared radially extending shoulder that defines an upper surface 121a surrounded by a rim 121b. The collared radially extending shoulder will receive therein, the annular flange 139 of the bushing 130 and the arm plate 140. The arm 104 can have an arcuate track 129 recessed into the arm arbor 105 proximate the bottom end 137. The arcuate track 186 defines or limits the degrees of rotation of the arm 104 about the first axis of rotation A. In the assembled state, the top end 135 of the arm arbor 105 is closed by the arm plate 140 and the bottom end 137 is seated on the base 102 to close the bottom end 137 as well.

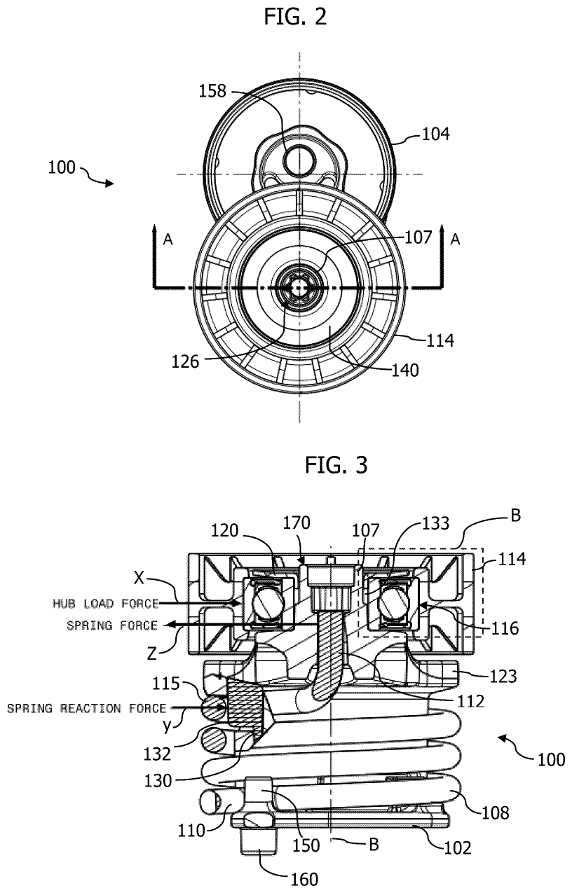

The arm 104 also includes the pulley pivot tube 107. The pulley pivot tube 107 has a top bore 125 (labeled in FIG. 5) and a bottom bore 127 (labeled in FIG. 6). The interior surface of the bottom bore 127 can include a spring tang registration feature 128. The spring registration feature 128 may be a flat surface or flat wall segment for a portion of the generally cylindrical bore 127. In another embodiment, the spring registration feature can be a key or keyway mateable to a respectively opposite feature on the second spring tang 112. The top bore 125 defines a recessed socket 126 therein, best seen in FIG. 2. The socket 126 is configured to receive a tool, especially a tool for lifting the tensioner arm (applying a force to the torsion spring to move the arm) once installed in an engine system to enable positioning of the endless belt around the pulley's belt engaging surface 117. In one embodiment, the socket 126 has a plurality of teeth-receiving features. The socket should have an adequate number of teeth-receiving features to reduce stripping the socket via slipping of the tool.

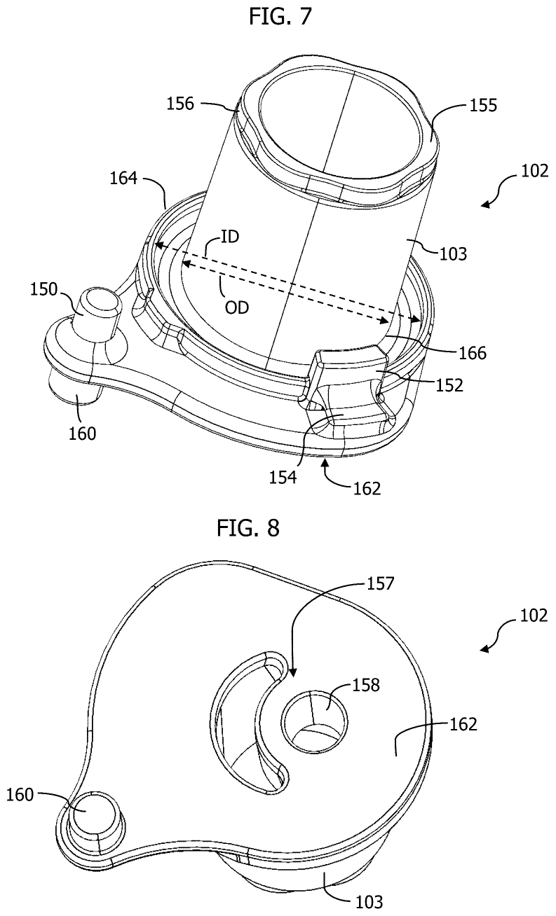

Turning now to FIGS. 1-4 and 7-8, the base 102, which includes the pivot tube 103, also includes a spring abutment feature 150 against which a first spring tang 110 is operatively seated to bias the arm 104 in the belt tensioning direction. The spring abutment feature 150 may be a protrusion on or a recess in the base 102. Opposite the spring abutment feature 150 is a registration pin 160 protruding downward away from the bottom surface 162, which may be referred to as the mounting surface, of the base. The registration pin 160 is configured to be received in a mating receptacle of an engine surface that is positioned to seat the belt tensioner 100 appropriately for engagement of the endless belt. The base 102 can include an arcuate tab 152 that is configured for engagement with the arcuate track 129 in the arm arbor 105. Extending radially outward from the arcuate tab 152 is a spring cradle 154. The spring cradle 154 is configured for a first coil 111 of the torsion spring to sit therein. The first coil 111 is the coil that extends from the first spring end 110.

The pivot tube 103 is open at its free end 155 and is generally closed at its opposing end 157. The opposing end 157 defines a bore 158 therethrough (best seen in FIGS. 2 and 8) configured to receive a mounting bolt for mounting the base 102, and hence the belt tensioner 100, to an engine surface. Referring to FIG. 8, the base 102 can include an annular flange 164 protruding axially upward in surrounding relationship to the pivot tube 103 and having an inner diameter ID that is greater than the outer diameter OD of the pivot tube 103 to space the annular flange 164 a distance from a base 166 of pivot tube 103. The gap defined therebetween is configured to receive the bottom end 137 of the arm arbor 105, thereby closing the arm arbor when the arm 104 and the base 102 are mated together in the assembled state. The free end 155 of the pivot tube 103 terminates with a splined or fluted exterior surface 156 configured for receiving the arm plate 140.

Referring again to FIGS. 1 and 4, the arm plate 140 is seated on the collared radially extending shoulder of the arm 104 in keyed engagement to a free end 155 of the pivot tube, more specifically with the splined or fluted exterior surface 156 of the pivot tube. The arm plate 140 encloses the bushing 130 in the arm 104. The arm plate 140 can be deformed during the installation procession to act as a spring plate to hold the components together. Examples of such methods are found in U.S. Pat. Nos. 6,575,860 and 9,249,866.

In operation, during normal tensioning, when a belt presses against pulley 114 that is attached to the arm 104, the arm will rotate about the pivot axis A thereby winding the torsion spring 108. The torsional spring upon winding will apply spring torque against the arm 104 to move, hold, or press the arm and pulley against the belt. As seen in FIG. 3, spring 108 is seated with its last coil 115 juxtaposed to the damper tab 132 of the bushing 130. Accordingly, when the arm 104 rotates in response to belt loading or other prevailing force(s) of the endless power transmitting element which is tightening in the span where the tensioner resides, the spring 108 will wind, decreasing the coil diameter, and radially contracting its coils into the damper tab 132, thereby directing the bushing 130 into frictional engagement with the pivot tube 103 of the base 102 to provide asymmetric damping. Then, when the belt loading or other prevailing force of the power transmitting element dissipates, the torque built up in the spring 108 urges the arm 104 to rotate in the tensioning direction T as the spring returns to its less wound state. As the spring 108 returns to its less wound state, the forces are reduced on the damper tab 132 and the bushing 130 disengages its frictional engagement with the pivot tube 103 of the base 102.

The arm 104 and base 102 can be manufactured from die-cast aluminum or other metals and some plastics if of sufficient strength for use in a vehicle engine environment. In one embodiment, the metal material is an aluminum or aluminum alloy. The torsion spring 108 may be manufactured from steel, but other suitable alternative materials (or combination of materials/components) to construct the spring are also contemplated. The arm plate 140 is, in an exemplary embodiment, a hardened steel plate and the bushing 130 is typically made of a wear resistant plastic. The wear resistant plastic can be, but is not limited to, all polyamides (PA) including 66 nylon, 6 nylon, 11 nylon, 12 nylon, 69 nylon, 612 nylon, and 610 nylon, polyamide 46 nylon; polyethermides (PEI); polysulfones (PSU); polyethersulfones (PES); polyoxymethylenes (POM), or acetals; polyetheretherketones (PEEK); polyphenylene sulfides (PPS); polypthalamides (PPS), or amodels; polyphenylene sulfides (PPO); and amorphous nylons.

One of the features of the belt tensioner discussed above is the attachment of the pulley without a bolt. One embodiment of a dust cover 120 was discussed above with respect to FIGS. 1-9, where the end 170 of the pulley pivot tube 107 was radially deformable outward to secure the dust cover 120 and hence the pulley 114 to the arm of the tensioner. With reference to FIGS. 10 and 11, rather than deform the pulley pivot tube 107, a retainer clip 180 is seated over and is operatively engaged to a reduced diameter stud 119 of the pulley pivot tube 107 and is operatively engaged to the dust cover 120. The retainer clip 180 is made from spring steel. The retainer clip 180 has an annular body 182 defining the outer diameter (OD). The annular body 182 has a plurality of tabs 183 extending radially inward that define the inner diameter (ID) and form a generally cone-shaped nose 184. Each of the plurality of tabs 183 is angled axially away from the annular body 182 and, when seated on the pulley pivot tube 107, are oriented axially away from the arm, pulley, and bearing, and have a generally flattened S-like-shaped profile in the longitudinal cross-section (see FIG. 10). The inner diameter (ID) is dimensioned to define a press fit to the pulley pivot tube 107, which as discussed above can be die-cast aluminum, and the axial deflection between points A and B (FIG. 10) defines an axial force through the dust cover 180 to the bearing 116 which secures both to the arm. The retainer clip 180 provides two points of retention with the dust cover 180 sandwiched between the retainer clip 180 and the bearing 116.

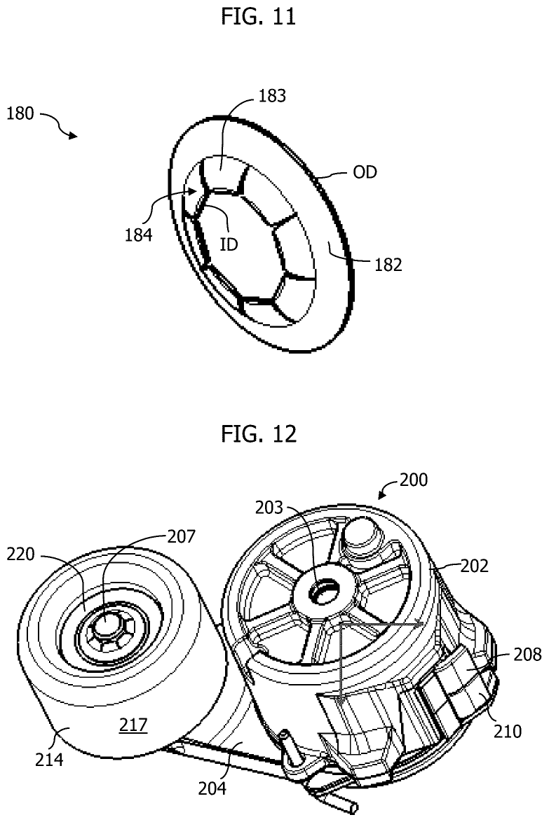

Turning now to FIGS. 12-18, rather than having a separate retainer clip 180, the retainer clip has been integrated into the dust cover, which will be referred to herein as a monolithic dust cover clip 220. The use of the retainer clip and separate dust cover and the monolithic dust cover clip 220 are not limited to the above disclosed belt tensioner, rather it is applicable to any belt tensioner, including a standard (non-Zed type) belt tensioner shown in FIG. 12. The belt tensioner of FIG. 12 has been given reference number 200 and has a support base or spring case 202 having a pivot tube 203 that defines a first axis of rotation, an arm 204 operatively seated over the pivot tube 203 for rotation about the first axis of rotation. The arm 204 includes a pulley mount 207 that defines a second axis of rotation. A torsion spring 208 is seated in the spring case 202 with a first spring end 210 attached to the spring case 202 and a second spring end (not visible in FIG. 12) operatively connected to the arm 204 to bias the arm in a direction, as is known to one of skill in the art, to apply tension to an endless belt of belt drive or engine system. A pulley 214 is seated on the pulley mount 207 for rotation about the second axis of rotation via a bearing 216 (see FIG. 14), such as a roller bearing having an inner race 221 and an outer race 222 with one or more roller bearings 224 seated therebetween. The pulley 214 has a belt engaging surface 217 and is secured to the pulley pivot tube 207 by one embodiment of the monolithic dust cover clip 220 (i.e., without the use of a pulley bolt).

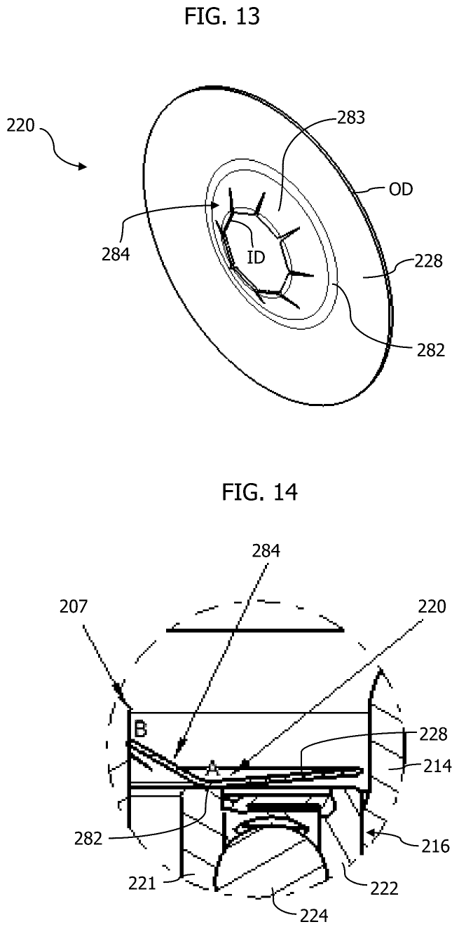

With reference to FIGS. 13 and 14, the monolithic dust cover clip 220 is seated over and is operatively engaged to the pulley pivot post/tube 207 and is operatively engaged with the inner race 221 of the bearing proximate point A with the annular perimeter portion 228 extending over the outer race 222 as a labyrinth seal (i.e., acting as the dust cover). The monolithic dust cover clip 220 is made from spring steel. The annular perimeter portion 228 defines the outer diameter (OD) and a plurality of tabs 283 extending radially inward define the inner diameter (ID) and form a generally cone-shaped nose 284. The cone-shaped nose 284 between points A and B as seen in FIG. 14 define a steeper angle than the embodiment of FIG. 10, thereby providing a stiffer retention force back to the pulley pivot post/tube 207. Each of the plurality of tabs 283 is angled axially away from the annular body 282 and, when seated on the pulley pivot post/tube 207, are oriented axially away from the arm, pulley, and bearing. The annular body 282 is the portion of the monolithic dust cover clip 220 that engages the roller bearing and is found between the annular perimeter portion 228 and the plurality of tabs 283. The inner diameter (ID) is dimensioned to define a press fit to the pulley pivot post/tube 207, which as discussed above can be die-cast aluminum, and the axial deflection between point A and B in FIG. 14 defines an axial force acting on the bearing, which secures both to the arm. The monolithic dust cover clip 220 provided two points of retention with for the same functionality described above but with a single part.

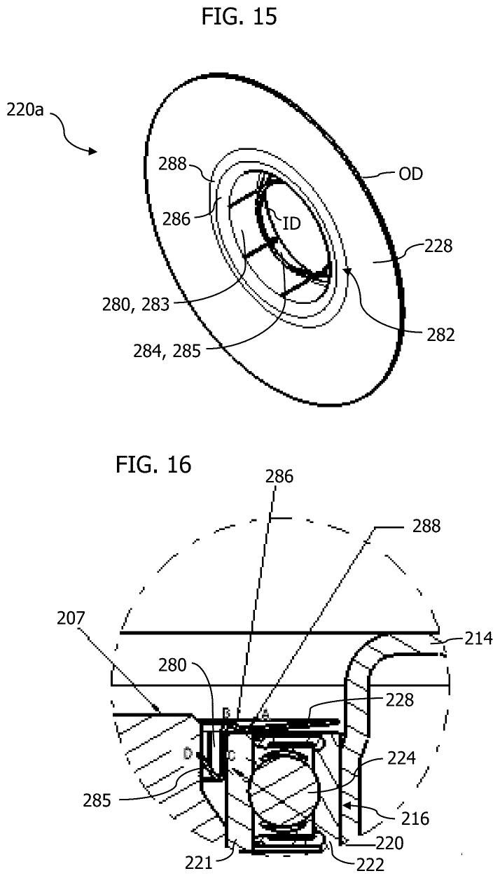

Turning to FIGS. 15 and 16, the monolithic dust cover clip 220a has a straight axial cup 280, that can be defined by a plurality of tabs 283, which terminates with a radially inward and axially upward oriented flange 285, defining a generally cone-shaped nose 284, and has an annular body section 282 between the straight axial cup 280 and an annular perimeter portion 228. The monolithic dust cover clip 220a is seated over and is operatively engaged to the pulley pivot post/tube 207 and is operatively engaged with the inner race 221 of the bearing with radial deflection between points C and D and axial deflection between points A and B with the annular perimeter portion 228 extending over the outer race 222 as a labyrinth seal (i.e., acting as the dust cover). The monolithic dust cover clip 220a is made from spring steel. The annular perimeter portion 228 defines the outer diameter (OD) and the flange 285 of the straight axial cup 280 defines the inner diameter (ID). Here, the straight cup 280 is pressed into the bore of the bearing 216 and is secured to the pulley pivot post 207 by both the axial and the radial forces of the monolithic dust cover clip 220a. The annular body 282 portion can include a concave portion 286 (noted as point B in FIG. 16) and a convex portion 288 (noted as point A in FIG. 16) is the portion of the monolithic dust cover clip 220a that engages the roller bearing and is found between the annular perimeter portion 228 and the plurality of tabs 283. The inner diameter (ID) is dimensioned to define a press fit to the pulley pivot post 207 and is pinched between the inner race of the bearing 216 and the outer surface of the pulley pivot post 207, which as discussed above can be die-cast aluminum. The monolithic dust cover clip 220a provides three points of retention and has an increased push-off force due to the initial point of contact, which allows for a shorter pulley pivot post 207.

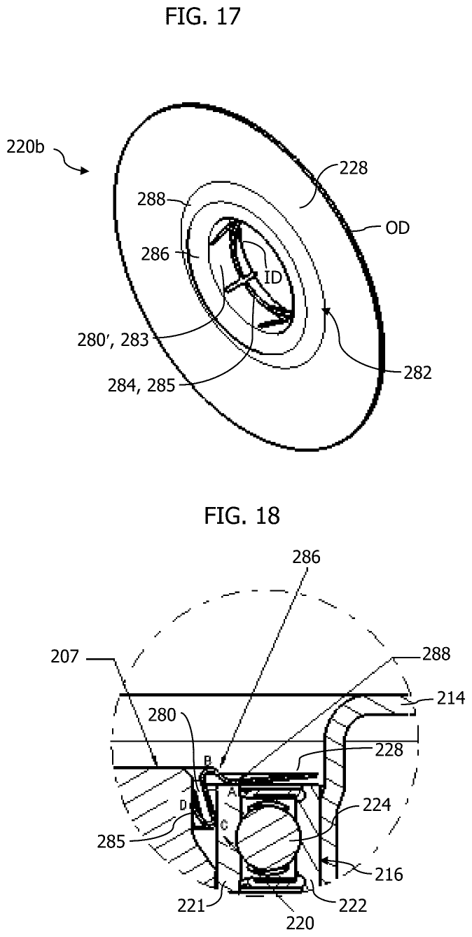

Turning to FIGS. 17 and 18, the monolithic dust cover clip 220b has a tapered axial cup 280′, that can be defined by a plurality of tabs 283, which terminates with a radially inward and axially upward oriented flange 285, defining a generally cone-shaped nose 284, and has an annular body section 282 between the straight axial cup 280′ and an annular perimeter portion 228. The taper introduced to the axial cup 280′ is between points C and B (see FIG. 18), thereby moving the convex portion 286 of the annular body section toward the pulley pivot post 207 and toward each of the plurality of tabs 283 toward the upward flange 285. The monolithic dust cover clip 220b is seated over and is operatively engaged to the pulley pivot post 207 and is operatively engaged with the inner race 221 of the bearing at point C and point A, with radial deflection between points C and D and axial deflection between points A and B, and with the annular perimeter portion 228 extending over the outer race 222 as a labyrinth seal (i.e., acting as the dust cover). The monolithic dust cover clip 220b is made from spring steel. The annular perimeter portion 228 defines the outer diameter (OD) and the flange 285 of the tapered axial cup 280′ defines the inner diameter (ID). Here, the tapered axial cup 280′ is pressed into the bore of the bearing 216 and is secured to the pulley pivot post 207 by both the axial and the radial forces of the monolithic dust cover clip 220b. The annular body 282 portion includes the convex portion 286 (noted as point B in FIG. 18) and a concave portion 288 (noted as point A in FIG. 18) (described relative to the exterior surface thereof) is the portion of the monolithic dust cover clip 220b that engages the roller bearing 216 and is found between the annular perimeter portion 228 and the plurality of tabs 283. The inner diameter (ID) is dimensioned to define a press fit to the pulley pivot post 207 and is pinched (to have a general Z-shape) between the inner race of the bearing 221 and the outer surface of the pulley pivot post 207, which as discussed above can be die-cast aluminum. The monolithic dust cover clip 220b provides three points of retention. This embodiment has an even greater increased push-off force due to complex shape and allows for a shorter pulley pivot post 207. When pinched, B does not need to contact the pulley pivot post 207, but it can be flush with the top of the pivot post 207.

The belt tensioners discussed herein have numerous advantages, many of which have been already discussed above. Some additional advantages are provided in this paragraph. The belt tensioners disclosed herein are advantageous because they eliminate the pulley bolt, which is more cost effective, and enables a spring end to be positioned inside the pivot tube of the pulley (in place of the bolt) for improved counterbalancing of the hub load. More specifically, the torsion spring, which can be a very durable round wire spring, has a spring force that counterbalances the hub load force and the spring reaction force, and the spring moves with the arm counteracting the hub load force through the entire rotation of the arm. Moreover, without the pulley bult, the bearing/pulley is secured to the pivot tube by the dust cover and/or a mounting ring, which prevents distortion of the inner race and is quicker to install. This design allows the arm of the belt tensioner to be as short as possible while the pulley can be as large as possible. Also, without a bolt, the opposing end of the pulley pivot tube can define a socket for receiving a tool to wind the tensioner during installation of the belt. Since the socket is a recessed feature, no decking height is added to the belt tensioner.

It should be noted that the embodiments are not limited in their application to the details of construction and arrangement of parts and steps illustrated in the drawings and description. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to preferred embodiments thereof, it will be apparent that modifications and variations are possible without departing from the scope of the invention which is defined in the appended claims.

What is claimed is:

1. A belt tensioner comprising:
a support base having a pivot tube that defines a first axis of rotation;
an arm operatively seated over the pivot tube for rotation about the first axis of rotation and having a pulley mount that defines a second axis of rotation;
a torsion spring has a first end in operative engagement with the support base and a second end in operative engagement with the arm to bias the arm in a belt tensioning direction; and
a pulley having a bearing seated on the pulley pivot tube and rotatable thereabout, wherein the pulley is secured to the pulley pivot tube by a monolithic dust cover clip without the use of a pulley bolt.

2. The belt tensioner of claim 1, wherein the arm has the pulley mount protruding from the arm in a direction opposite from an arm arbor, thereby defining a high-offset position for the pulley.

3. The belt tensioner of claim 2, wherein the pulley mount has an open end facing the spring and in which the second spring end is seated.

4. The tensioner of claim 3, further comprising an arm plate seated in a collared bowl of the arm arbor in engagement with a first end of the pivot tube.

5. The tensioner of claim 4, wherein the arm plate is deformed to act as a spring plate.

6. The belt tensioner of claim 1, wherein the base comprises a locating pin extending from a mounting surface of the base.

7. The belt tensioner of claim 6, wherein the locating pin is at a positioned opposite a spring abutment feature.

8. The belt tensioner of claim 2, wherein the torsion spring is an exposed torsion spring.

9. The belt tensioner of claim 1, wherein the pulley mount terminates with a reduced diameter stud against which the monolithic dust cover clip is seated.

10. The belt tensioner of claim 1, wherein the monolithic dust cover clip is press-fitted to the pulley mount and is in contact with an inner race of the bearing to provide an axial force on the bearing and has a dust cover flange extending over the upper surface of the bearing.

11. The belt tensioner of claim 10, wherein the monolithic dust cover clip has an axially extending generally cylindrical flange terminating with an upwardly angled annular lip that is press-fitted to the pulley mount with the cylindrical flange seated in the bore of the bearing against the inner race.

12. The belt tensioner of claim 11, wherein the monolithic dust cover clip includes an axial deflection as the transition between the cylindrical flange and the dust cover flange, wherein the axial deflection engages the mounting ring with the inner race of the bearing.

13. The belt tensioner of claim 12, wherein the generally cylindrical flange is angled radially outward to define a cone-shaped nose.

14. The belt tensioner of claim 10, wherein the dust cover flange is deflected upward to define a labyrinth seal over the upper surface of the bearing.
